(19) United States
(12) Patent Application Publication
(10) Pub. No.: US 2005/0076555 A1
(43) Pub. Date: Apr. 14, 2005

(54) Modular spin fishing system

(76) Inventor: Desmond J. Latouche, Kingsville (CA)

Correspondence Address: CONLEY ROSE, P.C., P. O. BOX 3267, HOUSTON, TX, 77253-3267, US

(21) Appl. No.: 10/684,765

(22) Filed: Oct. 14, 2003

(51) Int. Cl. A01K 87/00

(52) U.S. Cl. 43/18.1 R

(57) ABSTRACT

A modular fishing rod holder comprising an elongated hollow body which extends between an open front end and an open rear end. The body incorporates a nose cone at its rear end. Means at the front end of the body is provided to mate with and is detachably securable to one end of a rod. The fishing rod holder also comprises a reel housing body. One end of the reel housing body and the rear end of the hollow body are releasably attached so as to hold within, in operational position, a spinning reel.

### FIELD OF THE INVENTION

The present invention relates generally to spin fishing rigs. More particularly, the invention relates both to the complete encapsulation of the line from the inside of a closed face spinning reel to its exit at the end of a rod, by virtue of a series of specially designed rod holders, as well as the total modular inter changeability of a series of rods, rod holders and handles all emanating from one common reel housing body.

A common problem faced by people involved in the sport of fishing is that not a single type of fishing rig is appropriate for fishing every fish species, therefore more than one type of fishing rig is generally needed to be carried when it is desired to fish different species. Generally, different types of handles are also preferred by different anglers. In addition, some rigs can be rather cumbersome and difficult to carry and store in space restrictive circumstances such as camping, canoeing etc. An additional problem faced by some, especially the less experienced junior angler, is that presented by the line laying on the outside of the fishing rig, right from the point of leaving the face of the reel, all the way to the exit point of the line from the rod tip. This section of line is a sitting target for entanglement with belt buckles, watch straps, oar locks and other protrusions, including branches, brush etc. and can spell disaster for the unwary angler long before the lure takes flight for its target destination. Also in terms of the more inexperienced or junior angler, there is always a much greater possibility of damage or breakage of the typically delicate nature of a hollow section rod tip.

There have been attempts to resolve these problems in the prior art. For example U.S. Pat. No. 3,447,254 to Sobel et al. discloses a collapsible fishing rod which, while extendable to a length of more than six feet, is also retractable to a size of approximately six inches. The fishing rod is fixedly secured to the handle and therefore cannot be easily changed by a user. U.S. Pat. No. 2,578,477 to Hurd describes a fishing rig which combines fishing reel, rod seat and handle in a single housing with the rod fixedly attached thereto. U.S. Pat. No. 2,752,717 to Lind describes a fishing apparatus with an improved type of free-stripping reel. The rod is also fixedly attached to the rig. Canadian Patent 1,011,552 to Popeil describes a fishing rig wherein the rod is operatively connected to a latch, allowing for a folding of the rod beneath the cavity housing the fishing reel. This fishing rig however does not allow for a complete removal of the rod therefrom by a user.

Applicant's U.S. Pat. No. 5,444,934 describes a collapsible fishing rig adapted to releasably receive a reel which can be internal or external. The fishing rig according to this patent document does not however allow for a change of rods, rod holders or handles by the user, and its arrangement is not modular.

Although there have been attempts to resolve some of these problems in the past, there remains a need for a reliable, economic, completely user friendly, modular fishing system, which would allow an intrepid angler the benefit of being able to personally, easily modify a fishing rig at different times to suit the particular fishing need at that particular time and this invention is intended to fulfill that need.

### SUMMARY OF THE INVENTION

It is thus an object of one embodiment of the present invention to provide a modular spin fishing system which is economic, easy to manufacture and operate and which allows for the possibility for a user to easily change the rig when needed.

In accordance with an aspect of the invention, there is provided a modular fishing rig comprising an elongated hollow body extending between an open front end and an open rear end. The body incorporates a nose cone at its rear end. The front end of the body is provided with means to mate with and releasably secure corresponding means on one end of a rod. A reel housing body is also provided together with means at one of its end to permit releasable attachment of the reel housing body and the hollow body so as to hold within, in operational position, a spinning reel.

In accordance with another aspect, the invention provides the rod holder in combination with a rod, an end of which is provided with means to mate with and releasably secure to the means at the front end of the hollow body. Optionally, the rod can be hollow along its length. The rod can also be a telescoping rod adapted to be retractable within itself. The invention also provides in combination the holder with a spinning reel held within the reel housing body in operative position.

In accordance with yet another aspect of the invention the rod holder comprises two sections pivotally secured to each other at a pivot and locked by locking means in operative elongated position but rotateable about the pivot so that the rod is collapsible back on the reel housing body and handle when the lock means is released. Optionally, the locking means may comprise a spring loaded shot pin on one section which releasably engages within an aperture in a shot pin hood on the other section.

The holder can also be provided with a dual purpose line guide having a first aperture for guiding the fishing line into the inside of the rod and a second aperture in the form of a semi-circle for guiding the fishing line to leave the holder and be directed to an external surface of a conventional rod.

A rod tip made of solid rather than a hollow section of material can be used in conjunction with a guideless rod in which the line passes through the inside of the rod for special purposes such as in the case of a rod for the more “junior” fisherman who is more prone to damage the more delicate hollow section type of rod tip. The use of such a setup is achieved by the use of a specially designed combination rod ferrule and integral guide which is fitted to the second last section of the hollow rod. The special combination rod ferrule and guide has an eyelet built into the side of the ferrule, thus allowing the line to exit through the eyelet and proceed to the standard rod guide attached to the solid rod tip. The combination rod ferrule and guide is designed to allow the solid rod tip to telescope back in the hollow second last section for the purpose of folding the rig for transportation.

The modular spin fishing system according to the invention is simple, economical, easy to manufacture and operate and has an efficient security mechanism.

### BRIEF DESCRIPTION OF THE DRAWINGS

These and other objects and advantages of the invention will become apparent upon reading the following detailed description and upon referring to the drawings in which:

FIG. 1 is a perspective view of the modular fishing rod holder according to the invention with a rod secured thereto;

FIG. 2 is an exploded view of the fishing rod holder of FIG. 1 with the reel housing body partly broken away;

FIG. 3 is a perspective view of an alternative embodiment of the fishing rod holder according to the invention partly broken away and with a rod secured thereto;

FIG. 4 is a partial exploded view of the fishing rod holder of FIG. 3 partly broken away;

FIG. 5 is a perspective view, in partial section of the fishing rod holder of FIG. 1 showing the two sections pivoting;

FIG. 6 is a perspective view of multiple embodiments of the fishing rod holder in accordance with the present invention;

FIG. 7 is a perspective view, in partial section, of multiple embodiments of optional handles to be associated with the fishing rod holder in accordance with the present invention; and

FIG. 8 is a perspective view of multiple embodiments of multiple rods to be associated with the modular spin fishing system of the present invention.

While the invention will be described in conjunction with illustrated embodiments, it will be understood that it is not intended to limit the invention to such embodiment. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given similar reference numerals.

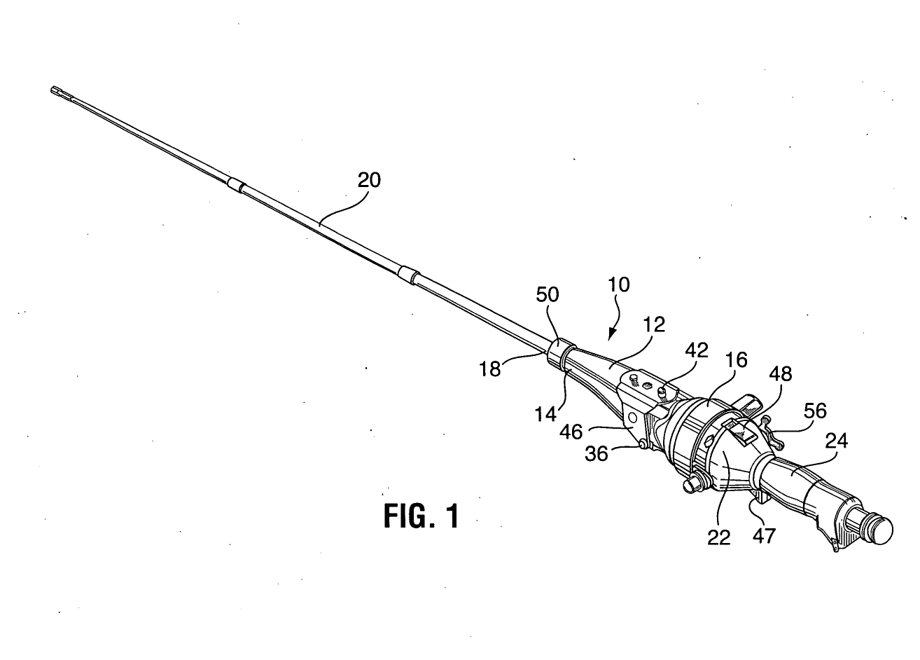

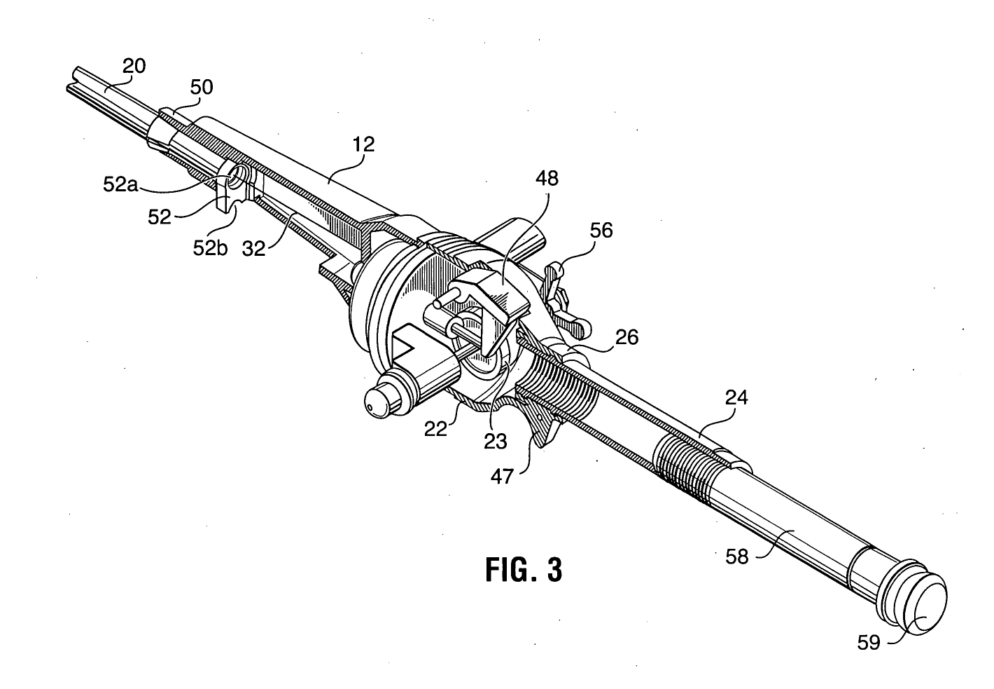

Turning to FIG. 1, there is shown a rod holder 10 for a fishing rod and reel. The rod holder comprises an elongated hollow body 12 which extends between an open front end 14 and an open rear end 16. The front end 14 of the rod holder is provided with means to mate with and releasably secure corresponding means on one end 18 of a rod 20. The rear end 16 of the rod holder and nose cone is provided with means to mateably secure to corresponding means on one end of a reel housing body 22 adapted to releasably secure and hold within, in operational position, a spinning reel 23 (FIG. 3).

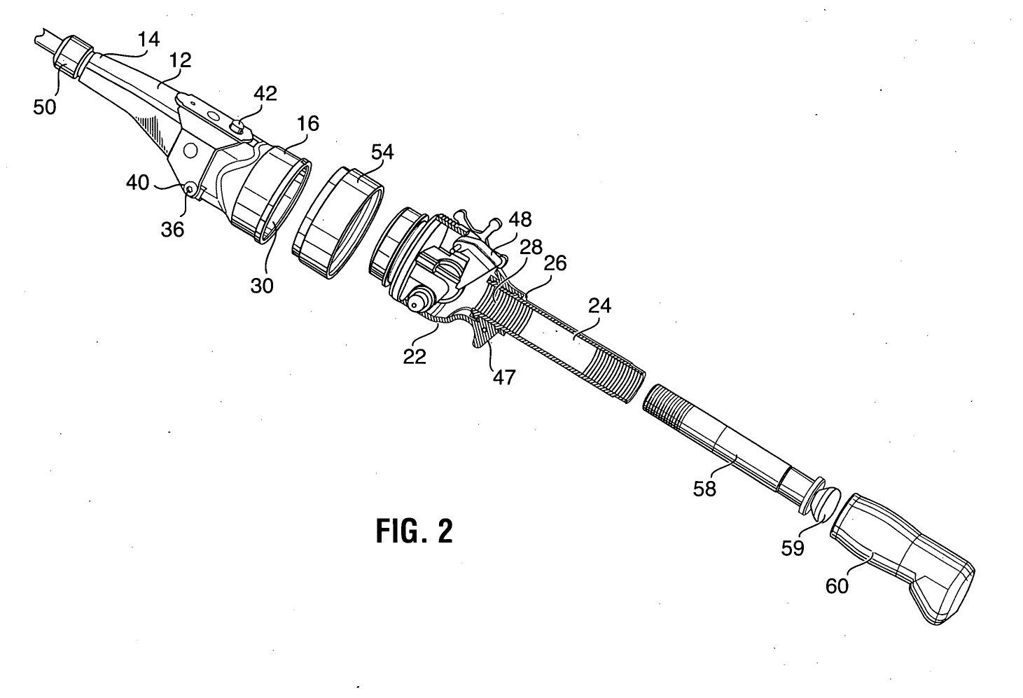

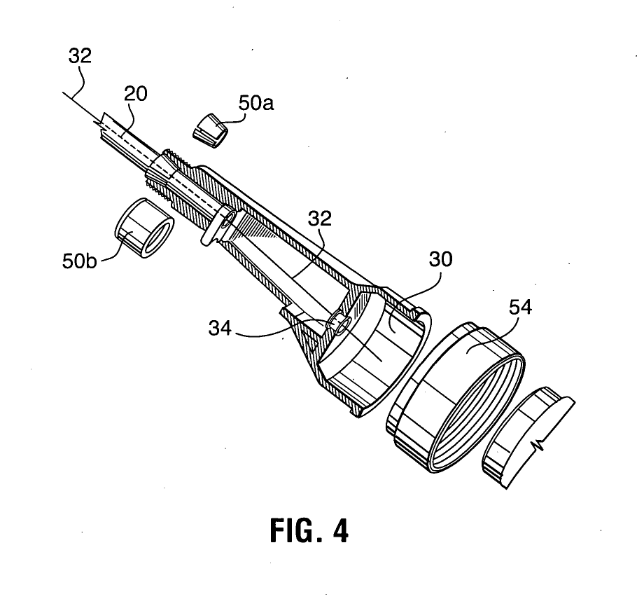

Rod holder 10 further comprises a handle means 24 secured to the other end 26 of the reel housing body 22. It should be contemplated that the other end 26 in FIG. 2 of the reel housing body is provided with means to mate with and releasably secure corresponding means on one end 28 of the handle means. The rear end of the non-folding rod holder according to the invention is in the form of a nose cone 30, as best illustrated in FIG. 4. The nose cone 30 has a concave inner surface so as to function with reel 23, as a clamp for a fishing line 32 during casting. Preferably, nose cone 30 is also provided with a nose cone guide ring 34 for guiding the fishing line 32, as best illustrated in FIG. 4.

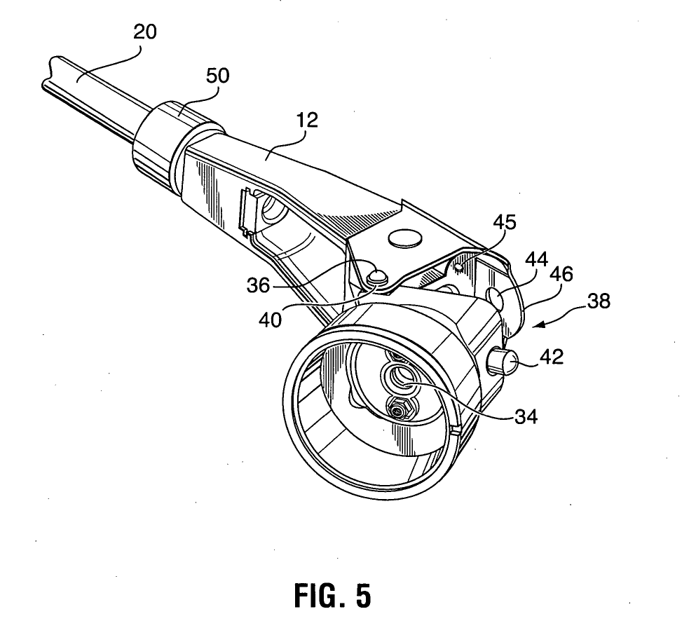

In the embodiment of the rod holder illustrated in FIG. 5, rod holder 10 is comprised of two sections. The two sections are pivotally secured to each other at a pivot 36, and locked by locking means 38 in operative elongated position but rotateable about the pivot 36, so that the rod is collapsible back on the reel cavity body and handle means when the lock means 38 is released. Preferably, the pivot is comprised of a pivot pin 36 secured to a pivot pin bracket 40 on the nose cone (best illustrated in FIG. 5), and the locking means 38 comprises a spring loaded shot pin 42 on one section, which releasably engages within an aperture 44 in a shot pin hood 46 on the other section. Protrusions 45 in FIG. 5 made of flexible material can be provided in the internal wall of one section of the holder. These protrusions act as bumpers to bias on the corresponding wall of the other section when the two sections are closed together as illustrated for example in FIG. 1. This contributes to hold the two sections tightly together, therefore preventing them from any likelihood of moving.

As can be seen in FIGS. 1 and 3, the reel housing body 22 of the holder may be provided with an integrally molded trigger for better grip 47. A thumb actuated line release 48 is operatively connected to the spinning reel 23 located inside the reel housing body for holding and then releasing the line during casting.

According to an aspect of the spin fishing system, one end 18 of the rod 20 is connected to the front end of the rod holder through a rod lock cap and sleeve arrangement 50. The sleeve 50a (FIG. 4) is a split sleeve and is adapted to fit the end of various types of fishing rod. The cap 50b is also adapted to fit various types of fishing rod and serves as a lock for holding the rod in place. More preferably, the fishing rod 20 is hollow along its length and is a telescoping rod adapted to be retractable inside itself.

According to another aspect, a line guide 52 for guiding the fishing line 32 may be provided. Line guide 52 has the form of a plate with a first internal aperture 52a for guiding the fishing line to the inside of the rod 20, and a second external aperture 52b having the form of a semi-circle for guiding the fishing line 32 to leave the holder and be directed to an external surface of a conventional rod, as best illustrated in FIG. 3.

According to yet another aspect, the rear end 16 of the nose cone 30 is releasably connected to the reel housing body 22 via a locking ring 54 which is adapted to mate with nose cone 30 and with the first end of the reel housing body. It should be noted that any other suitable releasable locking arrangement besides that illustrated in FIG. 2 can be used.

The rig according to the invention is provided with a left and right handed spinning reel 56, thus the rig can be used by both right and left handed people. In addition, the rig can be provided with an extendable handle body 24 releasably secured to the other end 26 of the reel cavity body. A soft pistol grip 60 (FIG. 2) can be formed to fit over the handle body 24, as illustrated for ease and comfort of handling.

An extension handle 58 and rear plug 59 provide storage for hooks, sinkers etc. and can be screwably extended for additional grip.

FIG. 3 illustrates an alternate embodiment of the rod holder according to the invention, wherein the two sections do not pivot, thus pivot pin and spring loaded shot pin are omitted.

In operation, the rod holder 10 is equipped with a rod 20 as illustrated in FIG. 1, with the cap 54b securely holding it in place. The spring loaded shot pin 38 is in locking position so that the two sections do not pivot. The locking ring 54 securely holds the rod holder nose cone and the reel housing body together, the housing being loaded with a spinning reel wrapped with fishing line and in operative position. The fishing rig is ready to be used for casting. The user holds the device through handle means 24 and detents the line release 48 with his thumb, thus releasing the fishing line while casting.

When it is desired to use a different type of rod, the user simply unlocks the cap 50b, removes the sleeve 50a and the rod, then installs another rod.

When it is desired to fold the holder of FIGS. 1, 2 and 5 for storage or to carry it to another location, the rod is retracted inside itself, spring loaded shot pin 38 is unlocked and the first section is pivoted back under the reel housing body and handle.

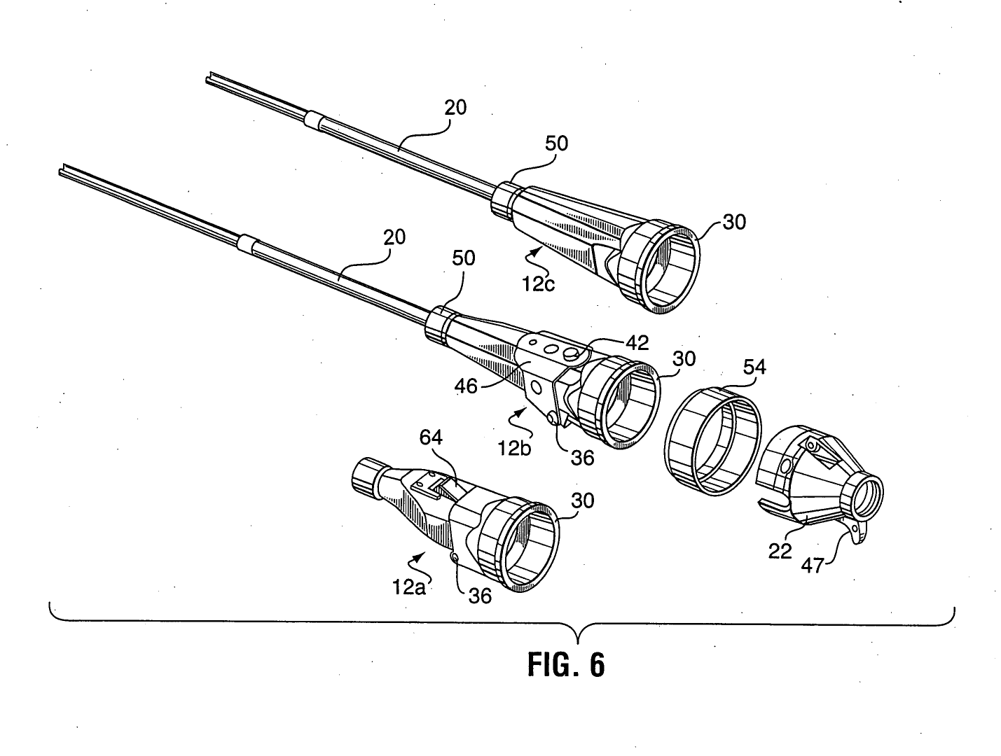

A number of interchangeable modular rod holders 12a, 12b and 12c are illustrated in FIG. 6. A common rod or rods 20 may be secured using, rod lock caps 50 at their front ends and nose cones 30 at their rear ends.

Rod holder 12c is a non-folding rod holder with an integral nose cone 30, as illustrated. Rod holder 12a is a basic folding rod holder, which folds about pivot pin 36 and has a conventional latch mechanism 64 for locking and unlocking the two sections of the rod holder so they do not pivot, and unlocking them to pivot. Rod holder 12b is a heavy duty folding rod holder having a shot pin hood 46 and shot pin release 42, as described and illustrated in FIGS. 1 and 5, the holder having two sections secured to each other and pivotable about pivot pin 36. A nose cone clamp ring 54 and reel housing body 22 with integral molded trigger 47 for better grip are illustrated in exploded fashion with respect to this holder 12b.

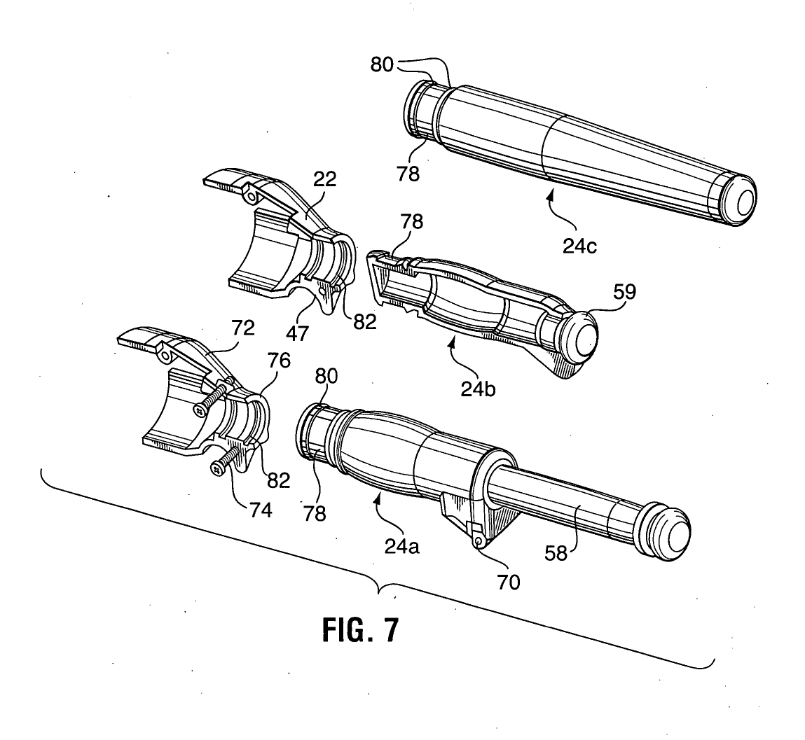

Turning to FIG. 7, there are illustrated a plurality of handles 24a, 24b and 24c for interchangeable use with the rods and rod holders of the present invention, by releasable connection to a standard reel housing body 22. Handle 24c is a normal straight handle with optional covering in cork, rubber or the like. Handle 24b, shown in section, is a molded plastic pistol grip handle with inside storage for hooks, sinkers and the like, and a removable plug 59. Handle 24a is a special pistol grip assembly with an extension handle 58 and may for instance be provided with a lanyard ring 70 for hanging on a belt, backpack etc. Associated with handle 24a is an optional modular reel housing body 72 (of which only half is shown) having clamp screws 74 and associated nuts for clamping and securing within its neck portion 76, the forward extension 78 of handle 24a , 24b or 24c. Annular rings 80 are mateably received in corresponding curves 82 in reel housing body 72. A similar ring 80/curve 82 securing means for handles is provided with the housing body 22 illustrated to be associated with handle 24b. In this case, however, the reel housing body 22 is a molded one so that a particular handle as selected is permanently held in place in the reel housing body 22.

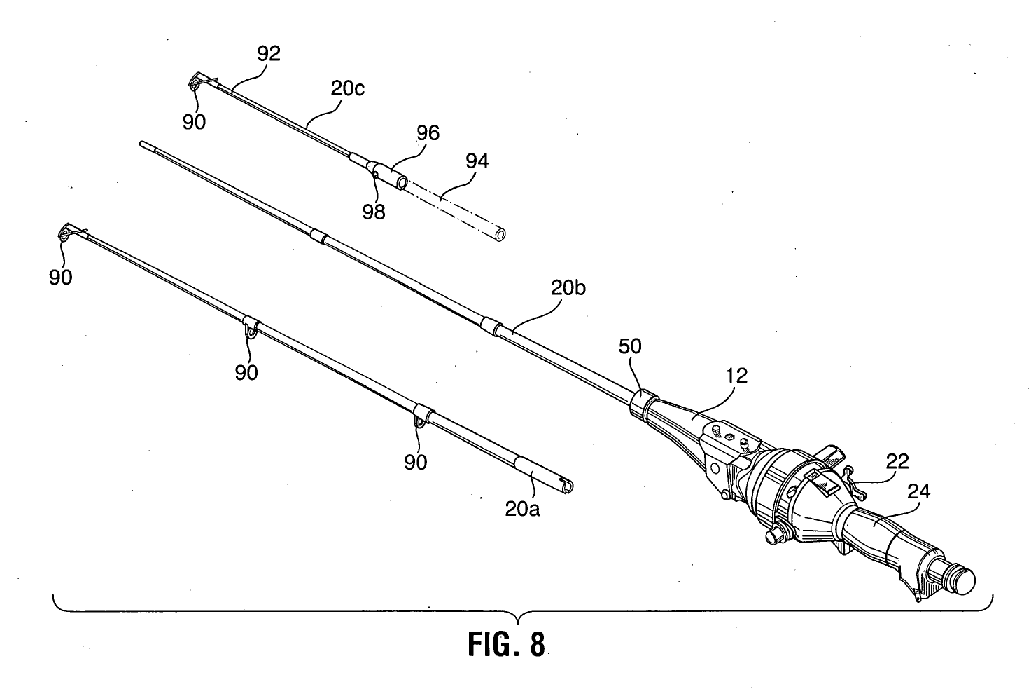

In FIG. 8, interchangeable modular rods 20a, 20b and 20c are illustrated, associated with a rod holder 12 and reel housing body 22 and handle 24 as illustrated in FIG. 1. Rod 20a is a standard rod with outside rod guide rings. Rod 20b is a hollow section rod with no outside guide rings, the line extending to the rod tip through the rods hollow central section. Rod 23 illustrates a standard solid rod tip 92 connected to a hollow section 94 by a special ferrule 96 which is provided with an eyelet 98 from which the line leaves the hollow section rod 94 (shown only partially) and passes through the end rod guide ring 90.

Thus, it will be understood that the present invention provides a modular spin fishing system which enables a great variety of rods, rod holders and handles.

Thus, it is apparent that there has been provided in accordance with the invention a modular spin fishing system that fully satisfies the objects aims and advantages set forth above, and which is economical and easy to operate. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A modular fishing rod holder comprising:
(a) an elongated hollow body extending between an open front end and an open rear end, the body incorporating a nose cone at its rear end;
(b) means at the front end to mate with and detachably secure corresponding means on one end of a rod;
(c) a reel housing body; and
(d) means at one end of the reel housing body and the rear end of the hollow body to permit releasable attachment of the reel housing body and hollow body so as to hold within, in operational position a spinning reel.

2. The fishing rod holder according to claim 1 further comprising a handle secured to the other end of the reel housing body.

3. The fishing rod holder according to claim 2, wherein the handle and the reel housing body are provided with mating engagement means for detachably securing the handle means to the reel housing body.

4. The fishing rod holder according to claim 1 in combination with a rod, an end of which rod is provided with means to mate with and detachably secure to said means at the front end of the holder.

5. The fishing rod holder and rod in accordance with claim 4, wherein the rod is hollow along its length.

6. The fishing rod holder according to claim 1, wherein the rear end of the hollow body is in the form of a nose cone having a concave inner surface so as to function as a clamp for a fishing line of a spinning reel during casting.

7. The fishing rod holder according to claim 2 in combination with a spinning reel held within the reel housing body in operative position.

8. The fishing rod holder according to claim 6 in combination with a spinning reel held within the reel housing body in operative position.

9. The fishing rod holder according to claim 7, wherein a fishing line is wrapped about the reel and extends through the front end of the hollow body.

10. The fishing rod holder according to claim 5 in combination with a spinning reel held within the reel housing body in operative position.

11. The fishing rod holder according to claim 10, wherein a fishing line is wrapped about the reel and extends through the front end of the hollow body and through the rod.

12. The fishing rod holder according to claim 7, wherein a handle means is secured to the other end of the reel housing body.

13. The fishing rod holder according to claim 12, wherein the handle is provided with means for releasable attachment to corresponding means on the other end of the reel housing body.

14. The fishing rod holder according to claim 2, wherein the rod holder is comprised of two sections pivotally secured to each other at a pivot and locked by locking means in operative elongated position but rotatable about the pivot so that the rod is collapsible back under the reel housing body and handle when the lock means is released.

15. The fishing rod holder according to claim 12, wherein the rod holder is comprised of two sections pivotally secured to each other at a pivot and locked by locking means in operative elongated position but rotatable about the pivot so that the rod is collapsible back under the reel housing body and handle when the lock means is released.

16. The fishing rod holder according to claim 14, wherein the locking means comprises a spring loaded shot pin on one section which releasably engages within an aperture in a shot pin hood on the other section.

17. The fishing rod holder according to claim 6, wherein the reel housing body is provided with a thumb actuated line release button operatively connected to the reel for releasing the fishing line during casting.

18. The fishing rod holder according to claim 1, wherein said means at the front end of the hollow body to mate with and detachably secure corresponding means at one end of the rod is a lock cap which is adapted to receive a split, tapered sleeve that is secured to the one end of the rod.

19. The fishing rod holder according to claim 5, wherein said elongated hollow body is provided with a line guide having a first aperture for guiding the fishing line inside the rod.

20. The fishing rod holder according to claim 19 further comprising a second semi-circular aperture for guiding the fishing line to leave the rod holder and be directed to an external surface of the rod.

21. The fishing rod holder according to claim 1, wherein said rod is a telescoping rod and is adapted to be retractable inside itself.

22. The fishing rod holder according to claim 4, wherein the rod comprises a hollow rod portion releasably securable to the holder and a conventional solid rod portion, the portions secured to each other by a ferrule having an aperture to lead a fishing line from the inside of the hollow rod section to the outside of the solid rod section.

23. The fishing rod holder according to claim 1 further comprising means on the reel housing body for releasable attachment to releasable securing means of the handle.

24. The modular fishing rod holder according to claim 23 in combination with the handle.
